(19) United States
(12) Patent Application Publication
(10) Pub. No.: US 2008/0277405 A1
(43) Pub. Date: Nov. 13, 2008

(54) Dispensing Apparatus Containing a Glove Stack and Method of Folding Gloves Therein

(76) Inventors: Michael P. Leach, Lewis Center, OH (US); Rob Davlin, Columbus, OH (US); Brice Bunner, Columbus, OH (US)

Correspondence Address: GALLAGHER & DAWSEY CO., L.P.A., P.O. BOX 785, COLUMBUS, OH, 43216, US

(21) Appl. No.: 11/747,273

(22) Filed: May 11, 2007

(51) Int. Cl. B65G 47/14; B65D 85/18; B65H 1/00; B65H 1/08

(52) U.S. Cl. 221/1; 206/285; 221/45; 221/59

(57) ABSTRACT

An apparatus containing a glove stack and method of folding gloves therein. The invention provides both an apparatus and a method to allow a plurality of generally disposable gloves to be folded in a compact manner, stored in a clean environment, and then dispensed individually from an enclosure. The enclosure may be a disposable wrapper which may further be contained within a dispenser housing having a dispenser aperture. The gloves may be enwrapped under compression, and may be compressed by the dispenser in order to facilitate packing and dispensing. The dispenser may have a bias, such as an expansible element, to urge gloves towards the dispensing aperture. In a preferred embodiment, the gloves may be dispensed thumb first, although other orientations are contemplated, and a novel method for folding the gloves to facilitate packing and dispensing is taught.

### TECHNICAL FIELD

The instant invention relates to systems for storing and dispensing gloves, and particularly, for storing gloves in a compact, interlocked stack so that they may be individually dispensed in a clean and efficient manner.

### BACKGROUND OF THE INVENTION

The disposable glove has become ubiquitous in modern industry, particularly in health care or food processing areas, but also in any area in which an inexpensive, and generally disposable, method has been desired for keeping the hands clean and for the containment of dirt, germs, or other contaminants. It is not uncommon for workers in many fields to be required to wear gloves while performing their duties, and many others who are not so required do so for simple hygienic reasons. The gloves which are typically used are often made of vinyl or polyethylene, and are often single-use, disposable items. Often times gloves are only worn for a few moments, such as while performing a medical procedure, and then are removed and discarded, leading to the consumption by a single user of a large number of gloves in a single work shift. While one commonly tends to think of medical gloves as being sterile, in fact, sterility is generally only required for surgical-type procedures. For the majority of medical uses, and for virtually all non-medical applications, it is sufficient for the gloves to be clean.

Handling gas station pumps, raw meats, pet cleanup, or other such application have similar issues in that these acts often require users to touch unclean items with their bare hands. Such handling creates significant opportunities for contamination and even illness once bare skin comes into contact with such surfaces or materials. Although products exist to keep hands clean, principally such as disposable gloves, such gloves do not have a convenient dispensing process or mechanism.

Of course, it is possible for disposable gloves to be stored loose, or loosely thrown in a box or bag. Such an arrangement is bulky, allows ingress of contaminants into the stored mass of gloves, and permits multiple and uncontrolled contamination of the entire mass when a glove is removed from the mass.

Slightly better is to pack the gloves in a random mass into a container with a dispenser outlet. This is marginally better for avoiding contamination, but the gloves will easily become tangled and often, more than one will be dispensed when the user attempts to pull a single glove from the container. The restricted size of the dispenser outlet may decrease the chances of multiple dispensing, but the user will often have to reach a finger into the outlet to attempt to dig out a free edge of glove to dispense it.

The instant invention solves many of these problems and answers a long-felt need. Gloves are stored in an exceedingly compact and neat manner, are resistant to multiple dispensing, and may be provided in a plurality of dispenser types.

### SUMMARY OF INVENTION

In its most general configuration, the present invention advances the state of the art with a variety of new capabilities and overcomes many of the shortcomings of prior devices in new and novel ways. The present invention overcomes the shortcomings and limitations of the prior art in any of a number of generally effective configurations. The instant invention demonstrates such capabilities and overcomes many of the shortcomings of prior methods in new and novel ways.

In a common embodiment, the glove stack enclosure may be a disposable wrapping covering a plurality of gloves and the gloves may be compressed and wrapped under compression within the glove stack enclosure. In general, gloves are designed to be dispensed one at a time from the glove stack through the glove stack enclosure aperture. While the number of gloves in the glove stack is limited only by practical considerations for the size of the stack, the apparatus includes at least a first glove and a second glove.

The gloves are folded with at least two transverse folds across the width of the gloves followed by at least three longitudinal folds along the length of the gloves. Detailed instructions on the folds and folding methods may be found in the Detailed Description of the Invention and the Claims, below.

At the conclusion of the folds of the various embodiments, the gloves are rendered into a neat and compact folded configuration. They may then be interposed into a stack so that they tend to be dispensed, through anything from a simple glove stack enclosure, or wrapper, to a more robust dispenser, in single-glove fashion.

Frictional effects may be seen between the gloves resulting from packaging the gloves in close proximity, possibly even under compression, in the glove stack enclosure, or wrapper. As each glove is dispensed, it tends to carry with it the next glove towards the dispensing aperture and to orient it correctly for dispensing. A bias may result from an expansible element incorporated in the enclosure or dispenser tending to urge the gloves in a particular dispensing direction.

Numerous methods of interposing a portion of the first glove and the second glove are possible, and no limitation is suggested by the instant invention as to such interposition. However, in a preferred embodiment, a portion of the thumb area of the first glove is interposed within an area created by a fold of the second glove.

Additionally, no limitation is intended that the first glove and the second glove be folded according to the same method. Any or all of the methods described below may include steps whereby the second glove is folded in the same folded configuration as the first glove, or steps by which the second glove is folded in a different manner from the first glove.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

### BRIEF DESCRIPTION OF THE DRAWINGS

Without limiting the scope of the present invention as claimed below and referring now to the drawings and figures:

FIG. 1 is a plan view of a glove according to the instant invention;

FIG. 2 is a side schematic view of a sequence of folds in the glove of FIG. 1;

FIG. 3.1 is a perspective view of a sequence of folds in the glove of FIG. 2;

FIG. 3.2 is a perspective view of a sequence of folds in the glove of FIG. 2, continued from FIG. 3.1;

FIG. 3.3 is a perspective view of a sequence of folds in the glove of FIG. 2, continued from FIG. 3.2;

FIG. 3.4 is a perspective view of a sequence of folds in the glove of FIG. 2; continued from FIG. 3.3;

FIG. 4 is a side schematic view of an alternate embodiment of a sequence of folds in the glove of FIG. 1;

FIG. 5.1 is a perspective view of a sequence of folds in the glove of FIG. 4;

FIG. 5.2 is a perspective view of a sequence of folds in the glove of FIG. 4, continued from FIG. 5.1;

FIG. 5.3 is a perspective view of a sequence of folds in the glove of FIG. 4, continued from FIG. 5.2;

FIG. 6 is a side schematic view of an alternate embodiment of a sequence of folds in the glove of FIG. 1;

FIG. 7.1 is a perspective view of a sequence of folds in the glove of FIG. 6;

FIG. 7.2 is a perspective view of a sequence of folds in the glove of FIG. 6, continued from FIG. 7.1;

FIG. 7.3 is a perspective view of a sequence of folds in the glove of FIG. 6, continued from FIG. 7.2;

FIG. 8 is an exploded perspective view of an embodiment of the glove stack of the instant invention showing a means of interposing a first glove and a second glove according to the instant invention;

FIG. 9 is a detail perspective view of the embodiment of the glove stack according to FIG. 8;

FIG. 10 is a perspective view showing one embodiment of a glove stack being received into a dispenser according to the instant invention; and

FIG. 11 is a perspective view of an embodiment of the assembled apparatus of the instant invention.

### DETAILED DESCRIPTION OF THE INVENTION

The dispensing apparatus containing a glove stack and method of folding gloves therein of the instant invention enables a significant advance in the state of the art. The preferred embodiments of the device accomplish this by new and novel arrangements of elements and methods that are configured in unique and novel ways and which demonstrate previously unavailable but preferred and desirable capabilities. The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

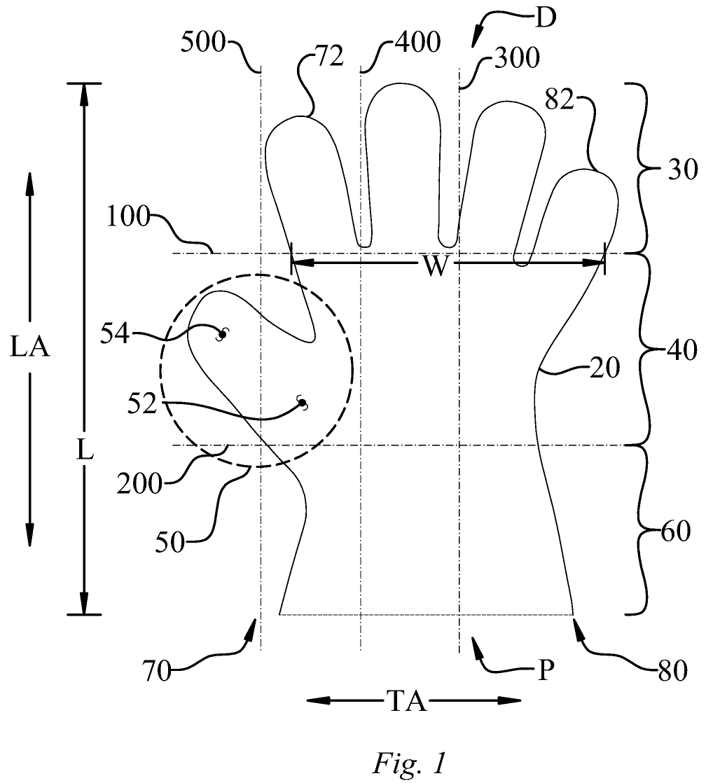

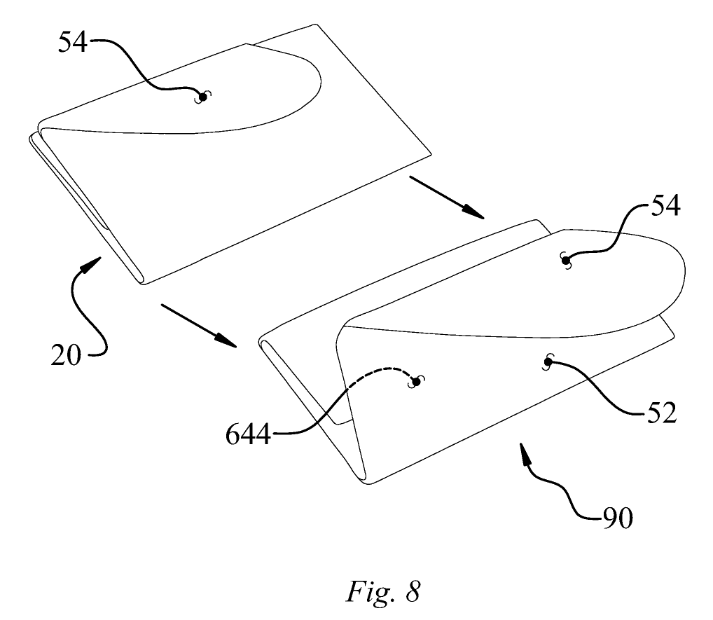

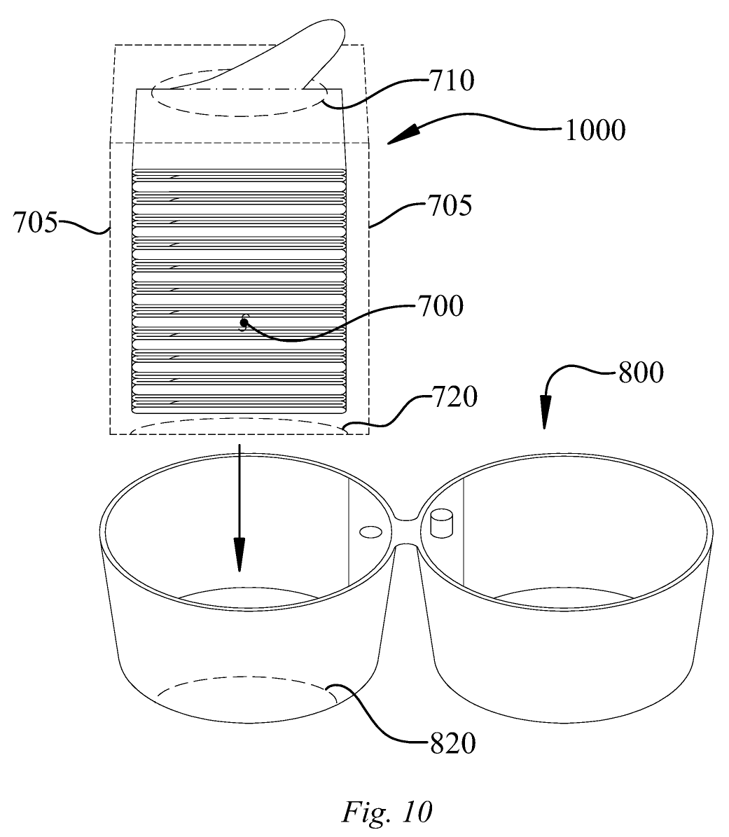

Referring now generally to FIGS. 1 through 11, the apparatus (1000) includes a glove stack (700) enwrapped in a glove stack enclosure (705) having a glove stack enclosure aperture (710). As seen in FIG. 10, in a common embodiment, the glove stack enclosure (705) may be a disposable wrapping covering a plurality of gloves (20, 90), and the gloves may be compressed and wrapped under compression within the glove stack enclosure (705). In general, gloves (20, 90) are designed to be dispensed one at a time from the glove stack (700) through the glove stack enclosure aperture (710). While a limit on the number of gloves in the glove stack (700) is limited only by practical considerations for the size of the stack (700), the apparatus includes at least a first glove (20) and a second glove (90), as seen in FIGS. 8 through 10.

Each glove (20, 90), as seen in FIG. 1, is possessed of a number of dimensions, aspects, and areas, as each glove (20, 90) has a length (L) and corresponding longitudinal axis (LA), and a width (W) and corresponding transverse axis (TA). Each glove also has a distal end (D) and a proximal end (P). Each glove (20, 90) has a flexion side (22) and an extension side (24), a thenar aspect (70) and a hypothenar aspect (80), a finger area (30) with a thenar-most digit (72) and a hypothenar-most digit (82). The gloves (20,90) may also be said to have general areas (40, 50, 60), and while these areas are given anatomical names, it is not intended that such anatomical names be strictly construed. These include a palmar area (40), a thumb area (50) and a wrist area (60). By way of example, it is possible that the palmar area (40) may cover parts of a wearer's fingers, or that the wrist area (60) may cover part of a wearer's palm.

By way of general orientation, when viewing the flexion side (22) of a glove (20, 90), as seen in FIG. 1, the thumb area (50), the thenar aspect (70) and the thenar-most digit (72) will all appear to the viewer's left; while the hypothenar area (80) and the hypothenar-most digit (82) will appear to the viewer's right. The gloves (20, 90) also will be disclosed in relation to various lines, and all such dimensions, aspects, areas, and lines, may be collectively considered reference points in the instant invention.

One skilled in the art will immediately understand at least two important factors in any discussion of such reference points.

Firstly, the term “lines” is not intended to require visually perceptible indicia on any part of the apparatus (1000), although visually perceptible indicia may appear in any part of the apparatus. Instead, lines are intended to encompass imaginary lines shown for illustration and illumination as to the means by which the apparatus (1000) is constructed, or the method with which the gloves (20, 90) may be folded.

Secondly, the substrate of the gloves (20, 90) may, by way of illustration only, be a wide variety of relatively flexible and expansible materials, such as polyethylene, vinyl, or rubber. Additionally, gloves (20, 90) of a type commonly used are made in a single size intended to fit all wearers, and are further often constructed in what may be termed an ambidextrous design, that is, the same glove (20, 90) is intended to fit either the left or right hand of the wearer.

For all these reasons, references to lines, areas, folds, and points determined by reference to such lines, areas, and folds, such as those seen in FIG. 1, must be somewhat approximate. As used therefore in this specification, the term “approximate” is intended to represent and include a variability of up to an including twenty percent variance from an exact measurement.

As seen in FIG. 1, the first glove (20) has a first transverse fold line (100) extending in the transverse axis (TA), with the first transverse fold line (100) approximately dividing the distal-most one third of the length (L) from the proximal-most two thirds of the length (L) and approximately dividing the finger area (30) from the palmar area (40). While, as seen in FIG. 1, length may be easily seen by one skilled in the art as the maximal distance between the proximal and the distal ends of the gloves (20, 90), width (W) shall be used in this specification to mean a width (W) of the glove (20, 90) along the first transverse fold line (100).

The first glove (20), again seen in FIG. 1, also has a second transverse fold line (200) extending in the transverse axis (TA) with the second transverse fold line (200) approximately dividing the distal-most two thirds of the length (L) from the proximal-most one third of the length (L) and approximately dividing the palmar area (40) from the wrist area (60).

Orthogonal to the first and second transverse fold lines (100, 200) the first glove (20) has three longitudinal fold lines (300, 400, 500), also as seen in FIG. 1. These longitudinal lines (300, 400, 500) are introduced out of numerical order, that is, first (300), third (500), second (400) because as will be seen immediately below, the position of the second longitudinal fold line (400) is defined by reference to the first (300) and third (500) longitudinal fold lines.

There is a first longitudinal fold line (300) extending in the longitudinal axis (LA) and approximately bisecting the width (W) of the glove at the first transverse fold line (100). There is a third longitudinal fold line (500) extending in the longitudinal axis (LA) and dividing the thumb area (50) into a first thumb area (52) and a second thumb area (54). There is also a second longitudinal fold line (400) extending in the longitudinal axis (LA) and located approximately midway between the first longitudinal fold line (300) and the third longitudinal fold line (500).

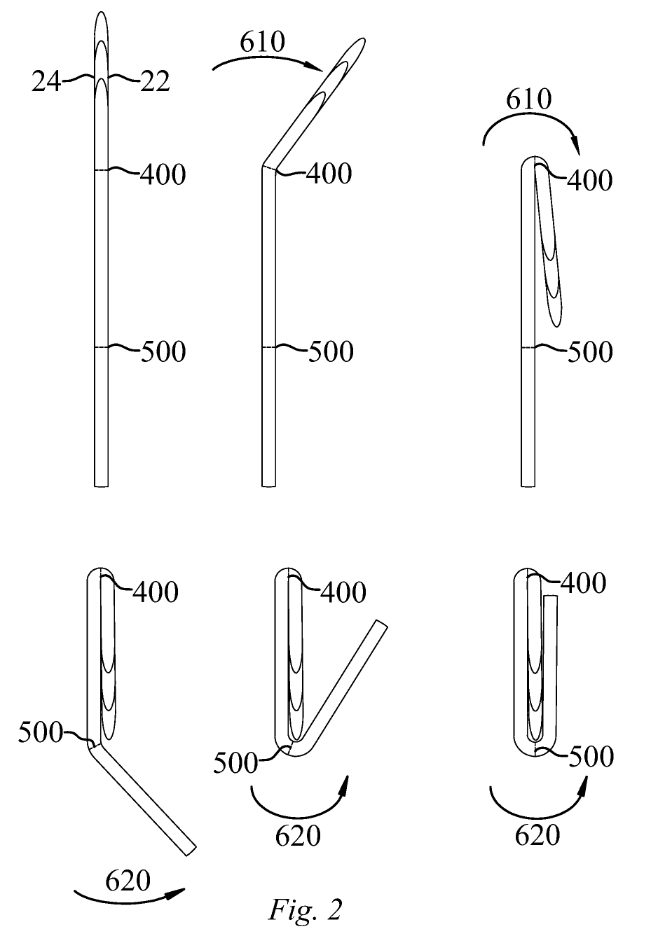

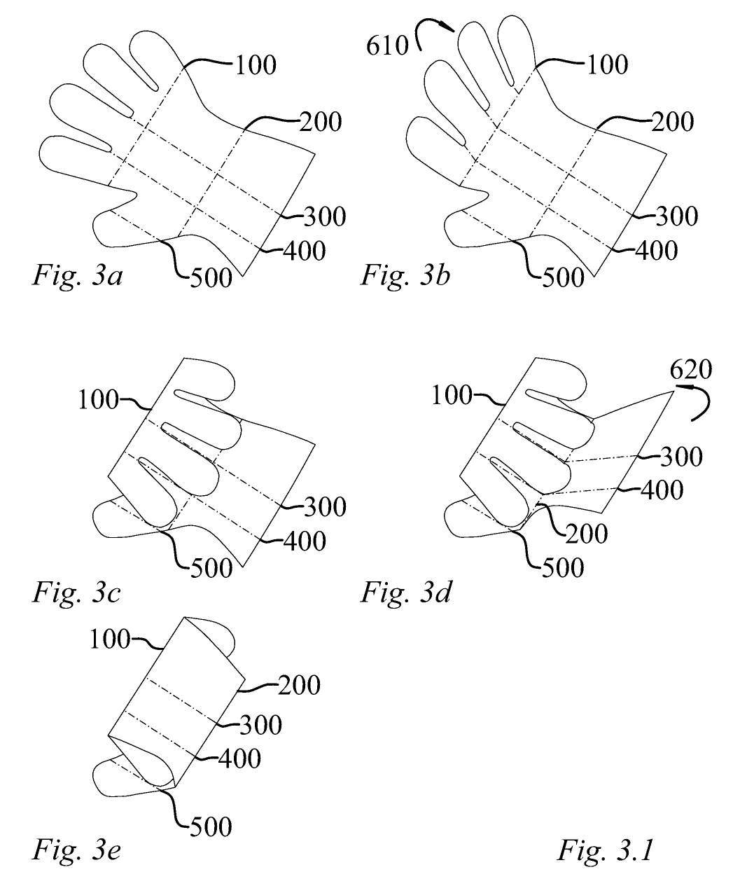

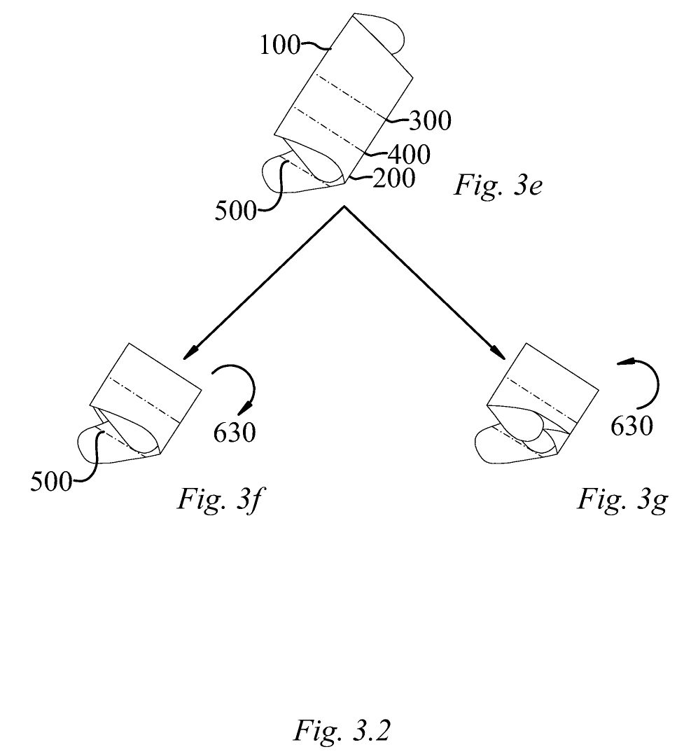

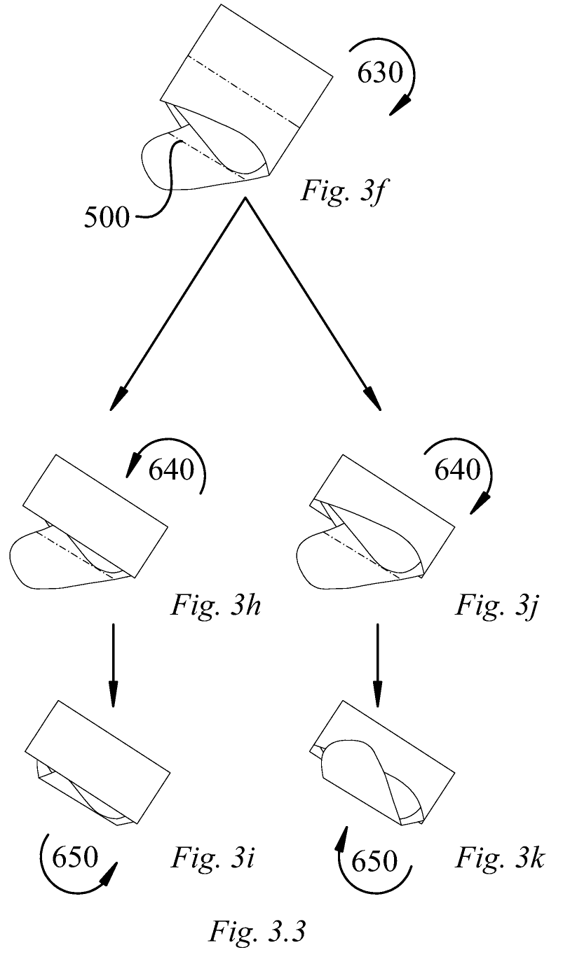

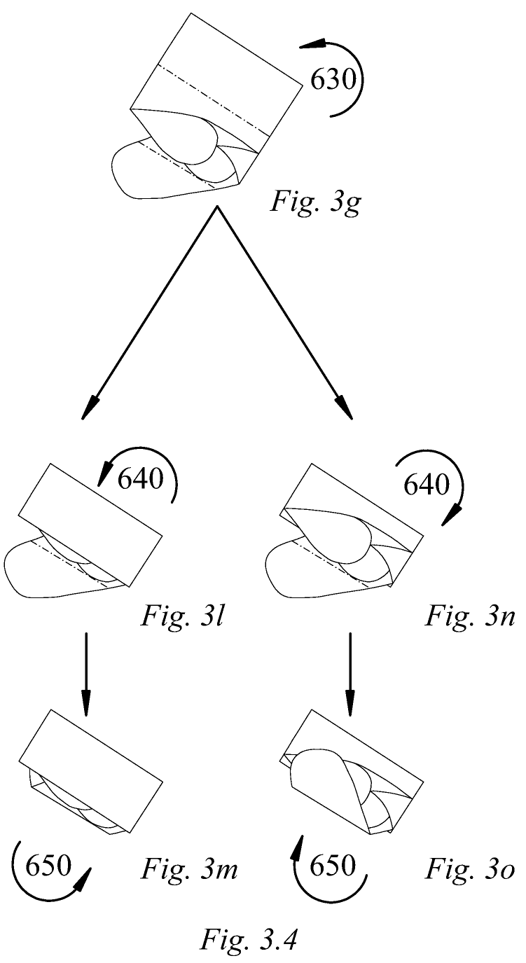

As seen in FIGS. 2 and 3, in one embodiment, the first glove (20) is folded in five folds (610, 620, 630, 640, 650). Two of the folds are transverse folds (610, 620) made in the transverse axis (TA), seen well in FIG. 2. There is a finger-palm fold (610) along the first transverse fold line (100) formed by rotating the finger area (30) about the first transverse fold line (100) in either the direction toward the flexion side (22) or toward the extension side (24). This causes the finger area (30) to overly and be in contact with the palmar area (40).

Also as seen in FIG. 2 and FIG. 3a-e, there is a wrist-palm fold (620) formed along the second transverse fold line (200) by rotating the wrist area (60) about the second transverse fold line (200) in the same direction as the finger-palm fold (610). This causes the wrist area (50) to overly and be in contact with the finger area (30).

As seen in FIGS. 3f-o, the three remaining folds (630, 640, 650) are longitudinal folds made in the longitudinal axis (LA) at approximately right angles with the transverse folds (610, 620). For purposes of clarity, a flow chart is presented of the claimed embodiments, with branching of the flow chart to show alternative steps as described in the claims. There is a primary longitudinal fold (630), seen in FIGS. 3f and 3g, along the first longitudinal fold line (300) formed by rotating the hypothenar aspect (80) toward the thenar aspect (70). This causes the hypothenar aspect (80) to overly and be in contact with the thenar aspect (70) of the glove (20). There is also a secondary longitudinal fold (640), seen well in FIGS. 3h, 3j, 3l, and 3n, along the second longitudinal fold line (400), formed by rotating the thenar aspect (70) toward the first longitudinal fold line (300) such that the thenar aspect (70) overlies and is in contact with the third longitudinal fold line (300). Lastly, there is a tertiary longitudinal fold (650), seen well in FIGS. 3i, 3k, 3m, and 3o, along the third longitudinal fold line (500) formed by rotating the second thumb portion (54) in a direction opposite to the secondary longitudinal fold (640).

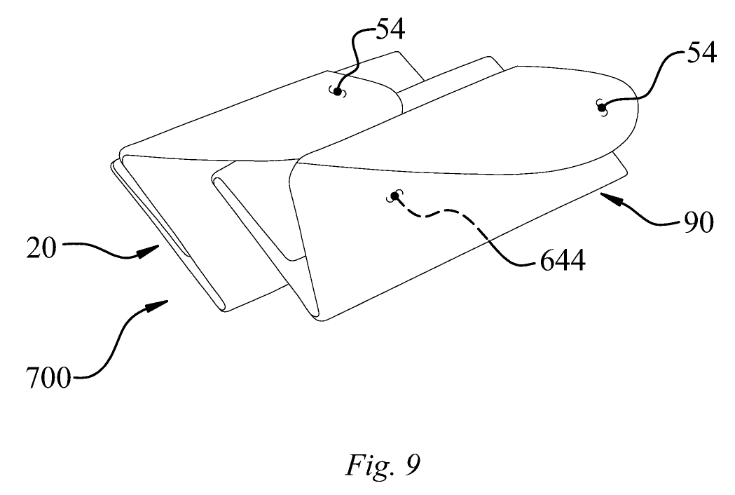

As seen in FIGS. 8 and 9, within the apparatus (1000), the glove stack (705) may be formed by interposing the second thumb portion (54) of the first glove (20) within an area created by a fold of the second glove (90). One skilled in the art will immediately see that the first glove (20) and second glove (90) may be representative of a much larger plurality of gloves forming the glove stack (705), as seen in FIG. 10.

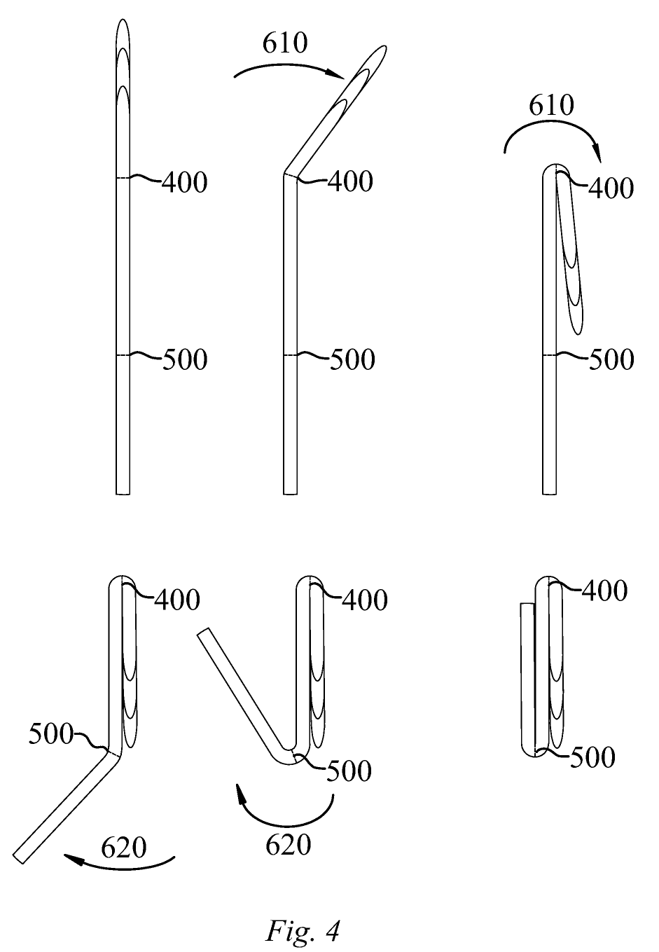

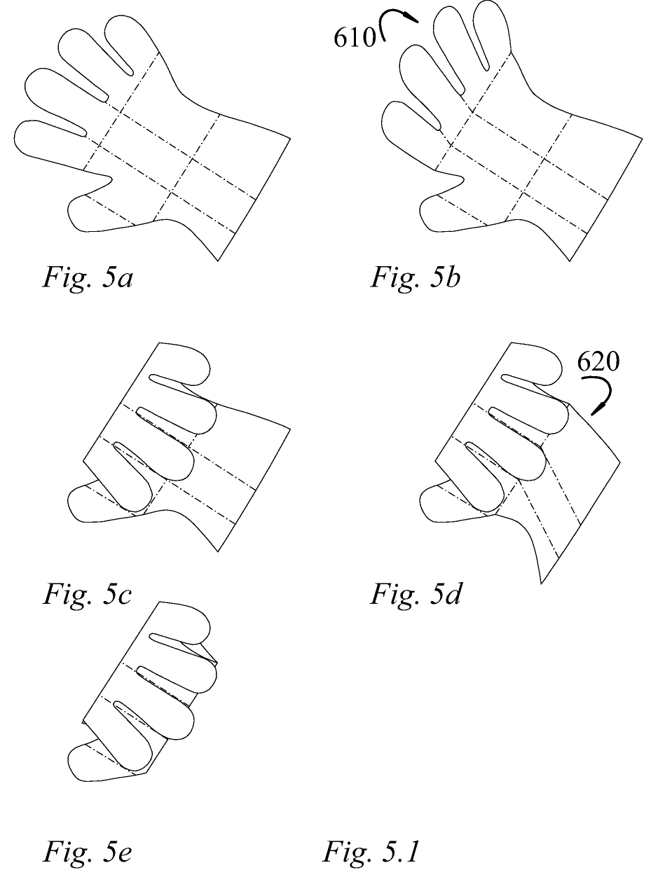

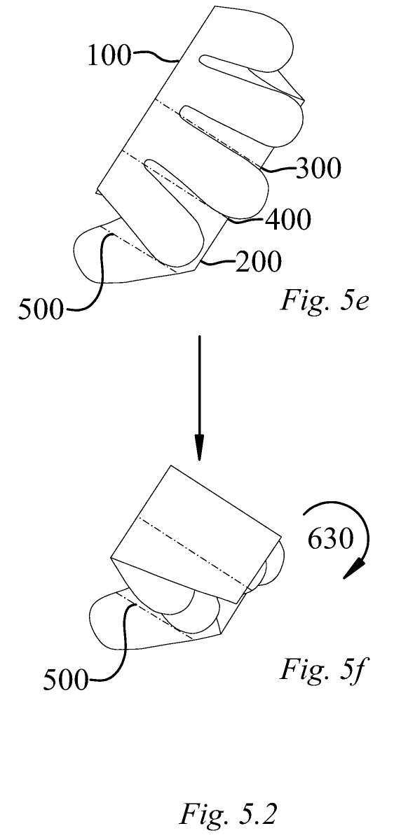

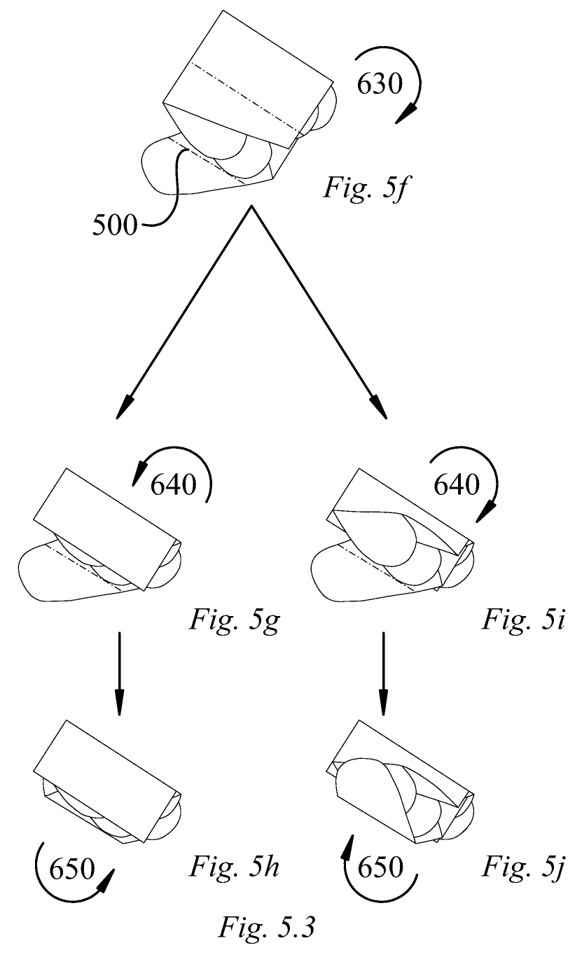

One skilled in the art will also immediately see that there are variations possible in the sequence and directions of folds in different embodiments. By way of example only, in an embodiment having the same fold lines (100, 200, 300, 400, and 500) discussed above, the following folds (610, 620, 630, 640, 650) may exist, as seen in FIGS. 4 and 5.

As seen in FIGS. 4 and 5b-c, there may be a finger-palm fold (610) along the first transverse fold line (100) formed by rotating the finger area (30) about the first transverse fold line (100) either toward the flexion side (22) or toward the extension side (24) such that the finger area (30) overlies and is in contact with the palmar area (40). There may also be a wrist-palm fold (620), seen in FIGS. 4 and 5d-e, formed along the second transverse fold line (200) by rotating the wrist area (60) about the second transverse fold line (200) in the opposite direction as the finger-palm fold (610), such that the wrist area (60) is thereby separated from the finger area (30) by the palmar area (40).

In such an embodiment, there may be a primary longitudinal fold (630), seen well in FIG. 5f, along the first longitudinal fold line (300) formed by rotating the hypothenar aspect (80) toward the thenar aspect (70) in a direction opposite to the wrist-palm fold (620). This causes the hypothenar aspect (80) to overly and be in contact with the thenar aspect (70) of the glove (20) and the hypothenar-most digit (82) to overly and be in contact with the thenar-most digit (72).

There may be a secondary longitudinal fold (640), seen well in FIGS. 5g and 5i, along the second longitudinal fold line (400) formed by folding the thenar aspect (70) toward the first longitudinal fold line (300) such that the thenar aspect (70) overlies and is in contact with the first longitudinal fold line (300). There also may be a tertiary longitudinal fold (650), seen well in FIGS. 5h and 5j along the third longitudinal fold line (500) formed by rotating the second thumb portion (54) toward the second longitudinal fold line (400) in a direction opposite to the secondary longitudinal fold (640).

As with the embodiment previously discussed, within the apparatus (1000), the glove stack (705) is formed by interposing the second thumb portion (54) of the first glove (20) within an area created by a fold of the second glove (90), as seen in FIGS. 8 and 9.

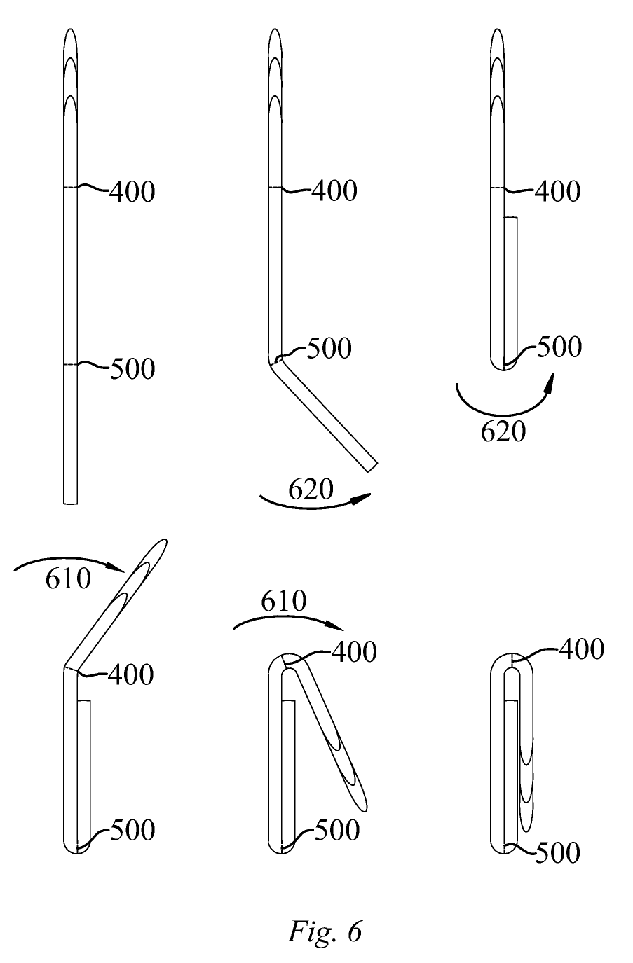

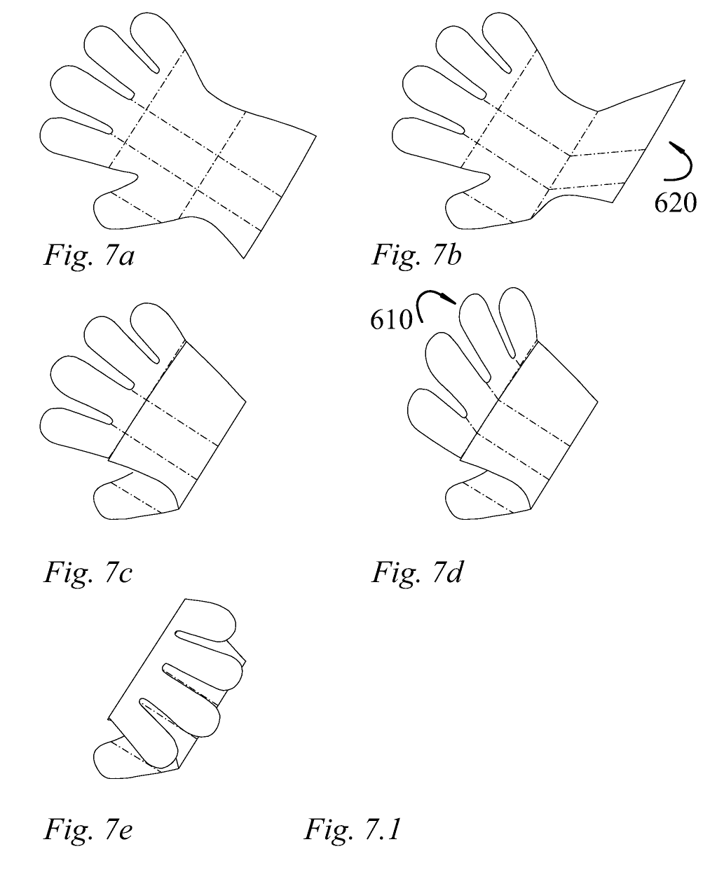

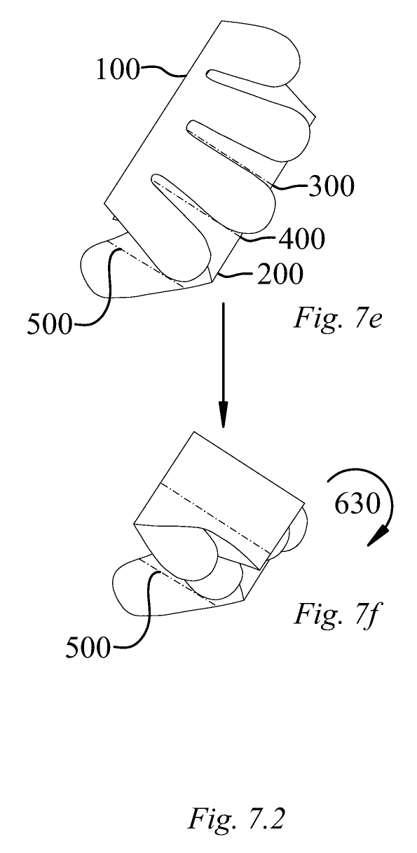

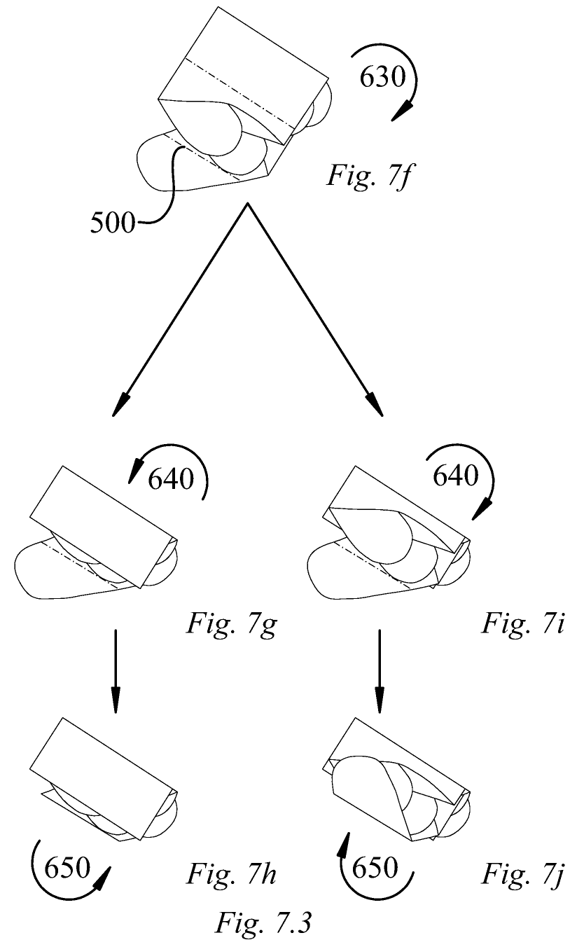

In yet another embodiment having the same fold lines (100, 200, 300, 400, and 500), discussed above, and as seen in FIGS. 6 and 7, the following folds (610, 620, 630, 640, 650) may exist. There may be a wrist-palm fold (620), seen in FIGS. 6 and 7b-c, along the second transverse fold line (200) formed by rotating the wrist area (60) about the second transverse fold line (200) such that the wrist area (60) overlies and is in contact with the palmar area (40).

Additionally, there may be a finger-palm fold (610), seen in FIGS. 6 and 7d-e, along the first transverse fold line (100), in the same direction as the wrist-palm fold (620), such that the finger area (30) overlies and is in contact with the wrist area (60).

There may also be a primary longitudinal fold (630), seen in FIG. 7f, along the first longitudinal fold line (300), formed by rotating the hypothenar aspect (80) toward the thenar aspect (70) in the same direction as the wrist-palm fold (620) and the finger-palm fold (610), such that the hypothenar aspect (80) overlies and is in contact with the thenar aspect (70) of the glove (20). This causes the hypothenar-most digit (82) to overly and be in contact with the thenar-most digit (72).

There may also be a secondary longitudinal fold (640), seen in FIGS. 7g and 7i, along the second longitudinal fold line (400), formed by folding the thenar aspect (70) toward the first longitudinal fold line (300) such that the thenar aspect (70) overlies and is in contact with the first longitudinal fold line (300). In addition, there may be a tertiary longitudinal fold (650), seen in FIGS. 7h and 7j, along the third longitudinal fold line (500), formed by rotating the second thumb portion (54) toward the second longitudinal fold line (400) in a direction opposite to the secondary longitudinal fold (640).

As with the other embodiments previously discussed, within the apparatus (1000), the glove stack (705) is formed by interposing the second thumb portion (54) of the first glove (20) within an area created by a fold of the second glove (90), as seen in FIGS. 8 and 9.

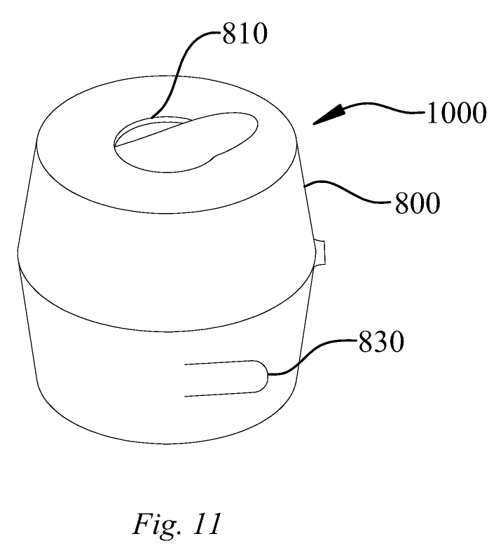

One skilled in the art will see that there are many additions possible to the apparatus (1000), and that any of these additions could be applied to any of the embodiments discussed above. For example, the apparatus (1000) may further include a dispenser housing (800) having a dispenser housing aperture (810), as seen in FIGS. 10 and 11. Such a dispenser housing (800) would at least partially enclose the glove stack (700) enwrapped in the glove stack enclosure (705).

The dispenser aperture (810) may also be adapted to dispense one glove at a time in an orientation that is thumb area (50) first, and there may be a dispenser bias (820) urging the glove stack (700) toward the dispenser aperture (810), seen in FIG. 10. Such a bias (820) would be understood by one skilled in the art to include any means of urging the gloves (20, 90) toward the glove stack enclosure aperture (710), such as a spring or other expansive element within the dispenser housing (800), and variations thereupon.

To aid in anchoring the apparatus (1000), the dispenser housing (800) may have a dispenser attachment (830), seen in FIG. 11, for attaching the dispenser housing (800) to an external object. One skilled in the art will understand that such an attachment (830) might include literally any means of securing one object to another, and would include such attachments (800) as clips, bands, adhesive, magnet, hook and loop fasteners, and others.

While numerous methods of interposing a portion of the thumb area (50) of the first glove (20) within an area created by a fold of the second glove (90) will be apparent to one skilled in the art, and no limitation is suggested by the instant invention as to such interposition. However, in a preferred embodiment, the area enclosed by a fold in the second glove (90) is an area (644) created by the secondary longitudinal fold (640), as seen in FIGS. 8 and 9.

The instant invention is intended to be equally useful when used without a dispenser housing (800) and wherein the glove stack (700) is enclosed only within a glove stack enclosure (705). Such construction could facilitate making the entire apparatus (1000) disposable. The dispenser aperture (810) may also be adapted to dispense one glove at a time in an orientation that is thumb area (50) first, although the invention is contemplated to include dispensing in any orientation as would be desired. There may also be a glove stack enclosure (705) that further includes a glove stack enclosure bias (720) urging the glove stack (700) toward the glove stack enclosure aperture (710), as seen in FIG. 10. Such a bias (720) would be understood by one skilled in the art to include any means of urging the gloves (20, 90) toward the glove stack enclosure aperture (710), such as a spring or other expansive element within the glove stack enclosure (705), and variations thereupon.

The apparatus (1000) may be configured such that second glove (90) is folded in the same folded configuration as the first glove (20), or may be configured such that the second glove (90) has a different folded configuration as the first glove (20) As is common in the field of items of this type, the first glove (20) and the second glove (90) may be disposable and or biodegradable.

One skilled in the art will of course appreciate that the embodiments of the apparatus (1000) discussed above lend themselves naturally to methods by which to construct such apparatus (1000). The following represent both an apparatus containing gloves (20, 90) and method of folding gloves and creating an interposed glove stack (700) having at least a first glove (20) and a second glove (90).

As seen in FIGS. 2 and 3, in one method of making the apparatus (1000), the gloves (20, 90) may have at least the following characteristics. As seen in FIG. 1, there may be at least a first glove (20) and a second glove (90), each having a length (L) and corresponding longitudinal axis (LA), and a width (W) and corresponding transverse axis (TA), a distal end (D) and a proximal end (P), a flexion side (22) and an extension side (24), a thenar aspect (70) and a hypothenar aspect (80), a finger area (30) with a thenar-most digit (72) and a hypothenar-most digit (82), a palmar area (40), a thumb area (50) and a wrist area (60).

Again as seen in FIG. 1, the first glove (20) may have a first transverse fold line (100) extending in the transverse axis (TA), with the first transverse fold line (100) approximately dividing the distal-most one third of the length (L) from the proximal-most two thirds of the length (L) and approximately dividing the finger area (30) from the palmar area (40). There may also be a second transverse fold line (200), again seen in FIG. 1, extending in the transverse axis (TA) with the second transverse fold line (200) approximately dividing the distal-most two thirds of the length (L) from the proximal-most one third of the length (L), and approximately dividing the palmar area (40) from the wrist area (60).

Also as seen in FIG. 1, there may also be a first longitudinal fold line (300) extending in the longitudinal axis (LA) and approximately bisecting the width (W) of the glove at the first transverse fold line (100). Further, there may be a third longitudinal fold line (500) extending in the longitudinal axis (LA) and dividing the thumb area (50) into a first thumb area (52) and a second thumb area (54).

There may be a second longitudinal fold line (400) extending in the longitudinal axis (LA) and located approximately midway between the first longitudinal fold line (300) and the third longitudinal fold line (500).

As seen in FIGS. 2 and 3, this embodiment of the method of forming the apparatus may include the steps of forming a finger-palm fold (610), seen in FIGS. 2 and 3b-c, along the first transverse fold line (100) formed by rotating the finger area (30) about the first transverse fold line (100) either toward the flexion side (22) or toward the extension side (24). This causes the finger area (30) to overly and to be in contact with the palmar area (40).

A further step may be forming a wrist-palm fold (620), again seen in FIGS. 2 and 3d-e, along the second transverse fold line (200) by rotating the wrist area (60) about the second transverse fold line (200) in the same direction as the finger-palm fold (610). This causes the wrist area (50) to overly and be in contact with the finger area (30).

As before, for purposes of clarity, a flow chart is presented of the claimed embodiments, with branching of the flow chart to show alternative steps as described in the claims. Further steps may include forming a primary longitudinal fold (630), seen in FIGS. 3f and 3g, along the first longitudinal fold line (300) by rotating the hypothenar aspect (80) toward the thenar aspect (70) such that the hypothenar aspect (80) overlies and is in contact with the thenar aspect (70) of the glove (20).

A further step may be forming a secondary longitudinal fold (640), seen in FIGS. 3h, 3j, 3l, and 3n, along the second longitudinal fold line (400) by rotating the thenar aspect (70) toward the first longitudinal fold line (300). This causes the thenar aspect (70) to overly and to be in contact with the first longitudinal fold line (300). Another step may include forming a tertiary longitudinal fold (650), seen in FIGS. 3i, k, 3m and 3o, along the third longitudinal fold line (500) by rotating a second thumb portion (54) in a direction opposite to the secondary longitudinal fold (640).

The apparatus (1000) may be formed in part by forming the glove stack (700) by the step of interposing the second thumb portion (54) of the first glove (20) within an area created by a fold of the second glove (90), as seen in FIGS. 8 and 9.

In yet another embodiment of the method, seen in FIGS. 4 and 5.1, an alternative embodiment of forming the apparatus may include the following steps. As seen in FIGS. 4 and 5b-c, an early step may include forming a finger-palm fold (610) along the first transverse fold line (100) by rotating the finger area (30) about the first transverse fold line (100) either toward the flexion side (22) or toward the extension side (24). This causes the finger area (30) to overly and is in contact with the palmar area (40).

Also as seen in FIGS. 4 and 5d-e, another step may include forming a wrist-palm fold (620) along the second transverse fold line (200) by rotating the wrist area (60) about the second transverse fold line (200) in the opposite direction as the finger-palm fold (610), such that the wrist area (60) is thereby separated from the finger area (30) by the palmar area (40), as seen in FIG. 5e.

A further step may include forming a primary longitudinal fold (630), seen in FIG. 5f, along the first longitudinal fold line (300) by rotating the hypothenar aspect (80) toward the thenar aspect (70) in a direction opposite to the wrist-palm fold (620), such that the hypothenar aspect (80) overlies and is in contact with the thenar aspect (70) of the glove (20). This causes the hypothenar-most digit (82) to overly and be in contact with the thenar-most digit (72).

A step may include forming a secondary longitudinal fold (640), seen in FIGS. 5g and 5i, along the second longitudinal fold line (400) by folding the thenar aspect (70) toward the first longitudinal fold line (100), such that the thenar aspect (70) overlies and is in contact with the first longitudinal fold line (100). Additionally, there may be a step of forming a tertiary longitudinal fold (650), seen in FIGS. 5h and 5j, along the third longitudinal fold line (500) formed by rotating the second thumb portion (54) toward the second longitudinal fold line (400) in a direction opposite to the secondary longitudinal fold (640).

As with the previous embodiment discussed, the apparatus (1000) may be formed in part by forming the glove stack (700) by the step of interposing the second thumb portion (54) of the first glove (20) within an area created by a fold of the second glove (90), as seen in FIGS. 8 and 9.

Yet another embodiment may encompass a different sequence of steps, as seen in FIGS. 6 and 7. As seen in FIG. 6, in one such embodiment, an early step may include forming a wrist-palm fold (620), seen also in FIG. 7b, along the second transverse fold line (200) by rotating the wrist area (60) about the second transverse fold line (200). This causes the wrist area (60) to overly and be in contact with the palmar area (40).

Another step may include forming a finger-palm fold (610), seen in FIGS. 6 and 7d-e, along the first transverse fold line (100) in the same direction as the wrist-palm fold (620) such that the finger area (30) overlies and is in contact with the wrist area (60). Yet another step may include forming a primary longitudinal fold (630), seen in FIG. 7f, along the first longitudinal fold line (300) by rotating the hypothenar aspect (80) toward the thenar aspect (70) in the same direction as the wrist-palm fold (620) and the finger-palm fold (610). This causes the hypothenar aspect (80) to overly and be in contact with the thenar aspect (70) of the glove (20) and the hypothenar-most digit (82) to overly and be in contact with the thenar-most digit (72).

Another step may include forming a secondary longitudinal fold (640), seen in FIGS. 7g and 7i, along the second longitudinal fold line (400) by folding the thenar aspect (70) toward the first longitudinal fold line (300). This causes the thenar aspect (70) to overly and be in contact with the second longitudinal fold line (400). Also, a step may include forming a tertiary longitudinal fold (650), seen in FIGS. 7h and 7j, along the third longitudinal fold line (500) by rotating a portion of the thumb area (50) toward the second longitudinal fold line (400) in a direction opposite to the secondary longitudinal fold (640).

As with both of the previous discussed embodiments of the method, the apparatus (1000) may be formed in part by forming the glove stack (700) by the step of interposing the second thumb portion (54) of the first glove (20) within an area created by a fold of the second glove (90), as seen in FIGS. 8 and 9.

One skilled in the art will see that there are many additions possible to the methods described above to form the apparatus (1000), and that any of these additions could be applied to any of the embodiments discussed above. Numerous methods of interposing a portion of the thumb area (50) of the first glove (20) within an area created by a fold of the second glove (90) are possible, and no limitation is suggested by the instant invention as to such interposition. However, in a preferred embodiment, the step of interposing a portion of the thumb area (50) of the first glove (20) within an area created by a fold of the second glove (90) may further include the step of interposing a portion of the thumb area (50) in an area (644) created by the secondary longitudinal fold (640), as seen in FIGS. 8 and 9.

Additionally, no limitation is intended that the first glove (20) and the second glove (90) be folded according to the same method. Any or all of the methods described above may include steps whereby the second glove (90) is folded in the same folded configuration as the first glove (20), or steps by which the second glove (90) is folded in a different manner from the first glove (20).

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

We claim:

1. A dispensing apparatus (1000) comprising;
a glove stack (700) enwrapped in a glove stack enclosure (705) having a glove stack enclosure aperture (710),
at least a first glove (20) and a second glove (90), each having a length (L) and corresponding longitudinal axis (LA), and a width (W) and corresponding transverse axis (TA), a distal end (D) and a proximal end (P), a flexion side (22) and an extension side (24), a thenar aspect (70) and a hypothenar aspect (80), a finger area (30) with a thenar-most digit (72) and a hypothenar-most digit (82), a palmar area (40), a thumb area (50) and a wrist area (60); wherein
(i) the first glove (20) has a first transverse fold line (100) extending in the transverse axis (TA), with the first transverse fold line (100) approximately dividing the distal-most one third of the length (L) from the proximal-most two thirds of the length (L) and approximately dividing the finger area (30) from the palmar area (40), and
(ii) a second transverse fold line (200) extending in the transverse axis (TA) with the second transverse fold line (200) approximately dividing the distal-most two thirds of the length (L) from the proximal-most one third of the length (L) and approximately dividing the palmar area (40) from the wrist area (60), and
(iii) a first longitudinal fold line (300) extending in the longitudinal axis (LA) and approximately bisecting the width (W) of the glove at the first transverse fold line (100), and
(iv) a third longitudinal fold line (500) extending in the longitudinal axis (LA) and dividing the thumb area (50) into a first thumb area (52) and a second thumb area (54), and
(v) a second longitudinal fold line (400) extending in the longitudinal axis (LA) and located approximately midway between the first longitudinal fold line (300) and the third longitudinal fold line (500), and wherein the first glove (20) is folded in a folded configuration further comprising;
(a) a finger-palm fold (610) along the first transverse fold line (100) formed by rotating the finger area (30) about the first transverse fold line (100) in a direction selected from the directions consisting of the directions toward the flexion side (22) and toward the extension side (24) such that the finger area (30) overlies and is in contact with the palmar area (40); and
(b) a wrist-palm fold (620) along the second transverse fold line (200) formed by rotating the wrist area (60) about the second transverse fold line (200) in the same direction as the finger-palm fold (610), such that the wrist area (50) overlies and is in contact with the finger area (30); and
(c) a primary longitudinal fold (630) along the first longitudinal fold line (300) formed by rotating the hypothenar aspect (80) toward the thenar aspect (70) such that the hypothenar aspect (80) overlies and is in contact with the thenar aspect (70) of the glove (20); and
(d) a secondary longitudinal fold (640) along the second longitudinal fold line (400) formed by rotating the thenar aspect (70) toward the first longitudinal fold line (300) such that the thenar aspect (70) overlies and is in contact with the third longitudinal fold line (300); and
(e) a tertiary longitudinal fold (650) along the third longitudinal fold line (500) formed by rotating the second thumb portion (54) in a direction opposite to the secondary longitudinal fold (640); and wherein;
the second thumb portion (54) of the first glove (20) is interposed within an area of the second glove (90)created by a fold of the second glove (90) thus forming the glove stack (700).

2. The apparatus according to claim 1, further comprising a dispenser housing (800) having a dispenser housing aperture (810) at least partially enclosing the glove stack (700) enwrapped in the glove stack enclosure (705).

3. The apparatus according to claim 2, wherein the dispenser aperture (810) is adapted to dispense one glove (20, 90) at a time in an orientation that is thumb area (50) first.

4. The apparatus according to claim 2, further comprising a dispenser bias (820) urging the glove stack (700) toward the dispenser aperture (810).

5. The apparatus according to claim 2, wherein the dispenser housing (800) further comprises a dispenser attachment (830) for attaching the dispenser housing (800) to an external object.

6. The apparatus according to claim 1, wherein the area enclosed by a fold in the second glove (90) is an area (644) created by the secondary longitudinal fold (640).

7. The apparatus according to claim 1, wherein the glove stack enclosure (705) is adapted to dispense one glove (20, 90) at a time in an orientation that is thumb area (50) first.

8. The apparatus according to claim 1, wherein the glove stack enclosure (705) further comprises a glove stack enclosure bias (720) urging the glove stack (700) toward the glove stack enclosure aperture (710).

9. The apparatus according to claim 1, wherein the second glove (90) is folded in the same folded configuration as the first glove (20).

10. The apparatus according to claim 1, wherein the first glove (20) and the second glove (90) are disposable.

11. The apparatus according to claim 1, wherein the first glove (20) and the second glove (90) are biodegradable.

12. A dispensing apparatus (1000) comprising;
a glove stack (700) enwrapped in a glove stack enclosure (705) having a glove stack enclosure aperture (710),
at least a first glove (20) and a second glove (90), each having a length (L) and corresponding longitudinal axis (LA), and a width (W) and corresponding transverse axis (TA), a distal end (D) and a proximal end (P), a flexion side (22) and an extension side (24), a thenar aspect (70) and a hypothenar aspect (80), a finger area (30) with a thenar-most digit (72) and a hypothenar-most digit (82), a palmar area (40), a thumb area (50) and a wrist area (60); wherein
(i) the first glove (20) has a first transverse fold line (100) extending in the transverse axis (TA), with the first transverse fold line (100) approximately dividing the distal-most one third of the length (L) from the proximal-most two thirds of the length (L) and approximately dividing the finger area (30) from the palmar area (40), and
(ii) a second transverse fold line (200) extending in the transverse axis (TA) with the second transverse fold line (200) approximately dividing the distal-most two thirds of the length (L) from the proximal-most one third of the length (L) and approximately dividing the palmar area (40) from the wrist area (60), and
(iii) a first longitudinal fold line (300) extending in the longitudinal axis (LA) and approximately bisecting the width (W) of the glove at the first transverse fold line (100), and
(iv) a third longitudinal fold line (500) extending in the longitudinal axis (LA) and dividing the thumb area (50) into a first thumb area (52) and a second thumb area (54), and
(v) a second longitudinal fold line (400) extending in the longitudinal axis (LA) and located approximately midway between the first longitudinal fold line (300) and the third longitudinal fold line (500), and wherein the first glove (20) is folded in a folded configuration further comprising;
(a) a finger-palm fold (610) along the first transverse fold line (100) formed by rotating the finger area (30) about the first transverse fold line (100) in a direction selected from the directions consisting of the directions toward the flexion side (22) and toward the extension side (24) such that the finger area (30) overlies and is in contact with the palmar area (40); and
(b) a wrist-palm fold (620) along the second transverse fold line (200) by rotating the wrist area (60) about the second transverse fold line (200) in the opposite direction as the finger-palm fold (610), such that the wrist area (60) is thereby separated from the finger area (30) by the palmar area (40); and
(c) a primary longitudinal fold (630) along the first longitudinal fold line (300) formed by rotating the hypothenar aspect (80) toward the thenar aspect (70) in a direction opposite to the wrist-palm fold (620), such that the hypothenar aspect (80) overlies and is in contact with the thenar aspect (70) of the glove (20) and the hypothenar-most digit (82) overlies and is in contact with the thenar-most digit (72); and
(d) a secondary longitudinal fold (640) along the second longitudinal fold line (400) formed by folding the thenar aspect (70) toward the first longitudinal fold line (300) such that the thenar aspect (70) overlies and is in contact with the first longitudinal fold line (300); and
(e) a tertiary longitudinal fold (650) along the third longitudinal fold line (500) formed by rotating the second thumb portion (54) toward the second longitudinal fold line (400) in a direction opposite to the secondary longitudinal fold (640); and wherein
the second thumb portion (54) of the first glove (20) is interposed within an area of the second glove (90) created by a fold of the second glove (90) thus forming the glove stack (700).

13. A dispensing apparatus (1000) comprising;
a glove stack (700) enwrapped in a glove stack enclosure (705) having a glove stack enclosure aperture (710),
at least a first glove (20) and a second glove (90), each having a length (L) and corresponding longitudinal axis (LA), and a width (W) and corresponding transverse axis (TA), a distal end (D) and a proximal end (P), a flexion side (22) and an extension side (24), a thenar aspect (70) and a hypothenar aspect (80), a finger area (30) with a thenar-most digit (72) and a hypothenar-most digit (82), a palmar area (40), a thumb area (50) and a wrist area (60); wherein
(i) the first glove (20) has a first transverse fold line (100) extending in the transverse axis (TA), with the first transverse fold line (100) approximately dividing the distal-most one third of the length (L) from the proximal-most two thirds of the length (L) and approximately dividing the finger area (30) from the palmar area (40), and
(ii) a second transverse fold line (200) extending in the transverse axis (TA) with the second transverse fold line (200) approximately dividing the distal-most two thirds of the length (L) from the proximal-most one third of the length (L) and approximately dividing the palmar area (40) from the wrist area (60), and
(iii) a first longitudinal fold line (300) extending in the longitudinal axis (LA) and approximately bisecting the width (W) of the glove at the first transverse fold line (100), and
(iv) a third longitudinal fold line (500) extending in the longitudinal axis (LA) and dividing the thumb area (50) into a first thumb area (52) and a second thumb area (54), and
(v) a second longitudinal fold line (400) extending in the longitudinal axis (LA) and located approximately midway between the first longitudinal fold line (300) and the third longitudinal fold line (500), and wherein the first glove (20) is folded in a folded configuration further comprising;
(a) a wrist-palm fold (620) along the second transverse fold line (200) by rotating the wrist area (60) about the second transverse fold line (200) such that the wrist area (60) overlies and is in contact with the palmar area (40); and
(b) a finger-palm fold (610) along the first transverse fold line (100) in the same direction as the wrist-palm fold (620) such that the finger area (30) overlies and is in contact with the wrist area (60); and
(c) a primary longitudinal fold (630) along the first longitudinal fold line (300) formed by rotating the hypothenar aspect (80) toward the thenar aspect (70) in the same direction as the wrist-palm fold (620) and the finger-palm fold (610) such that the hypothenar aspect (80) overlies and is in contact with the thenar aspect (70) of the glove (20) and the hypothenar-most digit (82) overlies and is in contact with the thenar-most digit (72); and
(d) a secondary longitudinal fold (640) along the second longitudinal fold line (400) formed by folding the thenar aspect (70) toward the first longitudinal fold line (300) such that the thenar aspect (70) overlies and is in contact with the first longitudinal fold line (300);
(e) a tertiary longitudinal fold (650) along the third longitudinal fold line (500) formed by rotating the second thumb portion (54) toward the second longitudinal fold line (400) in a direction opposite to the secondary longitudinal fold (640); and wherein
the thumb portion (54) of the first glove (20) is interposed within an area of the second glove (90) created by a fold of the second glove (90) thus forming the glove stack (700).

14. A method of folding gloves and creating an interposed glove stack (700) having at least a first glove (20) and a second glove (90) wherein:
at least a first glove (20) and a second glove (90), each having a length (L) and corresponding longitudinal axis (LA), and a width (W) and corresponding transverse axis (TA), a distal end (D) and a proximal end (P), a flexion side (22) and an extension side (24), a thenar aspect (70) and a hypothenar aspect (80), a finger area (30) with a thenar-most digit (72) and a hypothenar-most digit (82), a palmar area (40), a thumb area (50) and a wrist area (60); wherein
(i) the first glove (20) has a first transverse fold line (100) extending in the transverse axis (TA), with the first transverse fold line (100) approximately dividing the distal-most one third of the length (L) from the proximal-most two thirds of the length (L) and approximately dividing the finger area (30) from the palmar area (40), and
(ii) a second transverse fold line (200) extending in the transverse axis (TA) with the second transverse fold line (200) approximately dividing the distal-most two thirds of the length (L) from the proximal-most one third of the length (L) and approximately dividing the palmar area (40) from the wrist area (60), and
(iii) a first longitudinal fold line (300) extending in the longitudinal axis (LA) and approximately bisecting the width (W) of the glove at the first transverse fold line (100), and
(iv) a third longitudinal fold line (500) extending in the longitudinal axis (LA) and dividing the thumb area (50) into a first thumb area (52) and a second thumb area (54), and
(v) a second longitudinal fold line (400) extending in the longitudinal axis (LA) and located approximately midway between the first longitudinal fold line (300) and the third longitudinal fold line (500), comprising the steps of,
(a) forming a finger-palm fold (610) along the first transverse fold line (100) formed by rotating the finger area (30) about the first transverse fold line (100) in a direction selected from the directions consisting of the directions toward the flexion side (22) and toward the extension side (24) such that the finger area (30) overlies and is in contact with the palmar area (40); and
(b) forming a wrist-palm fold (620) along the second transverse fold line (200) formed by rotating the wrist area (60) about the second transverse fold line (200) in the same direction as the finger-palm fold (610), such that the wrist area (50) overlies and is in contact with the finger area (30); and
(c) forming a primary longitudinal fold (630) along the first longitudinal fold line (300) formed by rotating the hypothenar aspect (80) toward the thenar aspect (70) such that the hypothenar aspect (80) overlies and is in contact with the thenar aspect (70) of the glove (20); and
(d) forming a secondary longitudinal fold (640) along the second longitudinal fold line (400) formed by rotating the thenar aspect (70) toward the first longitudinal fold line (300) such that the thenar aspect (70) overlies and is in contact with the first longitudinal fold line (300); and
(e) forming a tertiary longitudinal fold (650) along the third longitudinal fold line (500) formed by rotating a second thumb portion (54) in a direction opposite to the secondary longitudinal fold (640); and wherein; and
forming the glove stack (700) by the step of interposing the second thumb portion (54) of the first glove (20) within an area of the second glove (90) created by a fold of the second glove (90).

15. The method according to claim 14, wherein the area created by a fold of the second glove (90) further comprises an area an area (644) created by the secondary longitudinal fold (640).

16. The method according to claim 14, wherein the second glove (90) is folded in the same folded configuration as the first glove (20).

17. A method of folding gloves and creating an interposed glove stack (700) having at least a first glove (20) and a second glove (90) wherein:
at least a first glove (20) and a second glove (90), each having a length (L) and corresponding longitudinal axis (LA), and a width (W) and corresponding transverse axis (TA), a distal end (D) and a proximal end (P), a flexion side (22) and an extension side (24), a thenar aspect (70) and a hypothenar aspect (80), a finger area (30) with a thenar-most digit (72) and a hypothenar-most digit (82), a palmar area (40), a thumb area (50) and a wrist area (60); wherein
(i) the first glove (20) has a first transverse fold line (100) extending in the transverse axis (TA), with the first transverse fold line (100) approximately dividing the distal-most one third of the length (L) from the proximal-most two thirds of the length (L) and approximately dividing the finger area (30) from the palmar area (40), and
(ii) a second transverse fold line (200) extending in the transverse axis (TA) with the second transverse fold line (200) approximately dividing the distal-most two thirds of the length (L) from the proximal-most one third of the length (L) and approximately dividing the palmar area (40) from the wrist area (60), and
(iii) a first longitudinal fold line (300) extending in the longitudinal axis (LA) and approximately bisecting the width (W) of the glove at the first transverse fold line (100), and
(iv) a third longitudinal fold line (500) extending in the longitudinal axis (LA) and dividing the thumb area (50) into a first thumb area (52) and a second thumb area (54), and
(v) a second longitudinal fold line (400) extending in the longitudinal axis (LA) and located approximately midway between the first longitudinal fold line (300) and the third longitudinal fold line (500), comprising the steps of,
(a) forming a finger-palm fold (610) along the first transverse fold line (100) formed by rotating the finger area (30) about the first transverse fold line (100) in a direction selected from the directions consisting of the directions toward the flexion side (22) and toward the extension side (24) such that the finger area (30) overlies and is in contact with the palmar area (40); and
(b) forming a wrist-palm fold (620) along the second transverse fold line (200) by rotating the wrist area (60) about the second transverse fold line (200) in the opposite direction as the finger-palm fold (610), such that the wrist area (60) is thereby separated from the finger area (30) by the palmar area (40);
(c) forming a primary longitudinal fold (630) along the first longitudinal fold line (300) formed by rotating the hypothenar aspect (80) toward the thenar aspect (70) in a direction opposite to the wrist-palm fold (620), such that the hypothenar aspect (80) overlies and is in contact with the thenar aspect (70) of the glove (20) and the hypothenar-most digit (82) overlies and is in contact with the thenar-most digit (72); and
(d) forming a secondary longitudinal fold (640) along the second longitudinal fold line (400) formed by folding the thenar aspect (70) toward the first longitudinal fold line (100) such that the thenar aspect (70) overlies and is in contact with the first longitudinal fold line (100); and
(e) forming a tertiary longitudinal fold (650) along the third longitudinal fold line (500) formed by rotating the second thumb portion (54) toward the second longitudinal fold line (400) in a direction opposite to the secondary longitudinal fold (640); and wherein;
forming the glove stack (700) by the step of interposing the second thumb portion (54) of the first glove (20) within an area of the second glove (90) created by a fold of the second glove (90).

18. The method according to claim 17, wherein the area created by a fold of the second glove (90) further comprises an area an area (644) created by the secondary longitudinal fold (640).

19. The method according to claim 17, wherein the second glove (90) is folded in the same folded configuration as the first glove (20).

20. A method of folding gloves and creating an interposed glove stack (700) having at least a first glove (20) and a second glove (90) wherein:
at least a first glove (20) and a second glove (90), each having a length (L) and corresponding longitudinal axis (LA), and a width (W) and corresponding transverse axis (TA), a distal end (D) and a proximal end (P), a flexion side (22) and an extension side (24), a thenar aspect (70) and a hypothenar aspect (80), a finger area (30) with a thenar-most digit (72) and a hypothenar-most digit (82), a palmar area (40), a thumb area (50) and a wrist area (60); wherein
(i) the first glove (20) has a first transverse fold line (100) extending in the transverse axis (TA), with the first transverse fold line (100) approximately dividing the distal-most one third of the length (L) from the proximal-most two thirds of the length (L) and approximately dividing the finger area (30) from the palmar area (40), and
(ii) a second transverse fold line (200) extending in the transverse axis (TA) with the second transverse fold line (200) approximately dividing the distal-most two thirds of the length (L) from the proximal-most one third of the length (L) and approximately dividing the palmar area (40) from the wrist area (60), and
(iii) a first longitudinal fold line (300) extending in the longitudinal axis (LA) and approximately bisecting the width (W) of the glove at the first transverse fold line (100), and
(iv) a third longitudinal fold line (500) extending in the longitudinal axis (LA) and dividing the thumb area (50) into a first thumb area (52) and a second thumb area (54), and
(v) a second longitudinal fold line (400) extending in the longitudinal axis (LA) and located approximately midway between the first longitudinal fold line (300) and the third longitudinal fold line (500), comprising the steps of,
(a) forming a wrist-palm fold (620) along the second transverse fold line (200) by rotating the wrist area (60) about the second transverse fold line (200) such that the wrist area (60) overlies and is in contact with the palmar area (40); and
(b) forming a finger-palm fold (610) along the first transverse fold line (100) in the same direction as the wrist-palm fold (620) such that the finger area (30) overlies and is in contact with the wrist area (60); and
(c) forming a primary longitudinal fold (630) along the first longitudinal fold line (300) formed by rotating the hypothenar aspect (80) toward the thenar aspect (70) in the same direction as the wrist-palm fold (620) and the finger-palm fold (610) such that the hypothenar aspect (80) overlies and is in contact with the thenar aspect (70) of the glove (20) and the hypothenar-most digit (82) overlies and is in contact with the thenar-most digit (72); and
(d) forming a secondary longitudinal fold (640) along the second longitudinal fold line (400) formed by folding the thenar aspect (70) toward the first longitudinal fold line (300) such that the thenar aspect (70) overlies and is in contact with the second longitudinal fold line (400);
(e) forming a tertiary longitudinal fold (650) along the third longitudinal fold line (500) formed by rotating a portion of the thumb area (50) toward the second longitudinal fold line (400) in a direction opposite to the secondary longitudinal fold (640); and wherein;
forming the glove stack (700) by the step of interposing the second thumb portion (54) of the first glove (20) within an area of the second glove (90) created by a fold of the second glove (90).

21. The method according to claim 20, wherein the area created by a fold of the second glove (90) further comprises an area an area (644) created by the secondary longitudinal fold (640).

22. The method according to claim 20, wherein the second glove (90) is folded in the same folded configuration as the first glove (20).
